(19) United States
(12) Patent Application Publication
(10) Pub. No.: US 2025/0128766 A1
(43) Pub. Date: Apr. 24, 2025

(54) LOWER STRUCTURE OF A VEHICLE BODY

(71) Applicants: HYUNDAI MOTOR COMPANY, Seoul (KR); KIA CORPORATION, Seoul (KR)

(72) Inventors: Hyun Soo Kim, Hwaseong-si (KR); Jinkyo Choung, Hwaseong-si (KR)

(73) Assignees: HYUNDAI MOTOR COMPANY, Seoul (KR); KIA CORPORATION, Seoul (KR)

(21) Appl. No.: 18/824,455

(22) Filed: Sep. 4, 2024

(30) Foreign Application Priority Data
Oct. 20, 2023 (KR) 10-2023-0141181

(51) Int. Cl. B62D 21/15; B60L 50/60; B60L 50/64; B62D 25/02; H01M 50/242; H01M 50/249

(52) U.S. Cl. CPC B62D 21/157; B60L 50/64; B60L 50/66; B62D 25/025; H01M 50/242; H01M 50/249; H01M 2220/20

(57) ABSTRACT

A lower structure of a vehicle body includes a side sill mounted along a front-to-back direction of the vehicle body, a battery mounted at a bottom of a center floor, and a side connecting member provided to transmit a collision load between the side sill and a battery.

### CROSS-REFERENCE TO RELATED APPLICATION

This application claims priority to and the benefit of Korean Patent Application No. 10-2023-0141181 filed in the Korean Intellectual Property Office on Oct. 20, 2023, the entire contents of which are incorporated herein by reference.

### BACKGROUND

### (a) Field of the Disclosure

The present disclosure relates to a lower structure of a vehicle body. More particularly, the present disclosure relates to a lower structure of a vehicle body with improved performance in distributing side collision loads.

### (b) Description of the Related Art

As the size of electric vehicle batteries increases, there is an increasing trend to mount high voltage batteries on the lower part of the center floor in an electric vehicle.

Accordingly, in preparation for the strengthening regulations on side or pole collision, research is required on the connection structure between the lateral and longitudinal members of the vehicle body and the lateral members of the battery to protect the high voltage battery.

Particularly, in the case of the 5th generation battery (CTP or Cell To Pack), the battery dimension in the width direction is reduced and the number of transverse members of the battery is reduced. Thus, the connection between the side sill inner and the longitudinal member of the vehicle body and the battery transverse member may be severed.

The subject matter described in this Background section has been described to improve understanding of the background of the disclosure. Therefore, the Background section may include subject matter that is not prior art already known to those of ordinary skill in the art in the field to which this technology belongs.

### SUMMARY

To compensate for for the foregoing problems, an appropriate design of the collision path (load path) between the vehicle body and the battery that can minimize the deformation caused by collision is required.

The present disclosure provides a lower structure of a vehicle body with improved performance in distributing side collision loads.

A lower structure of a vehicle body according to an embodiment may include a side sill mounted along the front-to-back direction of the vehicle body, a battery mounted at the bottom of a center floor of the vehicle body, and a side connecting member provided to transmit collision load between the side sill and the battery.

The side connecting member may include an inner protruding portion connected to a battery lateral member mounted along the width direction of the vehicle body to form or define an inner load path.

The side connecting member may further include an outer protruding portion connected to a seat cross-member mounted on the upper part of the center floor along the width direction of the vehicle body to form or define an outer load path.

The inner protruding portion may be formed to protrude to the inside of the vehicle body. The outer protruding portion may be formed on the outside of the vehicle body toward the side sill.

The outer protruding portion may include a side sill support supporting the side sill.

The side connecting member may further include an upper surface at an upper portion thereof to connect to the center floor.

The lower structure according to an embodiment may further include a vehicle body longitudinal member mounted along the front-to-back direction of the vehicle body on the inside of the vehicle body rather than on the side sill.

The side connecting member may further include a connector member body surrounding the vehicle body longitudinal member.

The inner protruding portion and the outer protruding portion may be connected with the connector member body.

The inner protruding portion, the outer protruding portion, and the connector member body may be integrally formed.

The side connecting member may further include a longitudinal member bulk head mounted inside the vehicle body longitudinal member.

The inner protruding portion and the outer protruding portion may be connected to the vehicle body longitudinal member.

The inner protruding portion may include a load transfer end formed or disposed inside the vehicle body. An imaginary extension of the battery lateral member may be directed or in the direction toward the load transfer end.

An imaginary extension of the seat cross-member may be directed or in the direction toward the side sill support.

According to an embodiment of a lower structure of a vehicle body, the performance of distributing lateral collision loads is improved, thereby preventing excessive deformation of the vehicle body and damage to the battery.

In addition, according to an embodiment of a lower structure of a vehicle body, a side connecting member is applied to improve the connection performance between the vehicle body and the battery, whereby the distribution of collision load is effective.

In addition, effects that can be obtained or expected due to embodiments of the present disclosure are disclosed directly or implicitly in the detailed description of the embodiments of the present disclosure. In other words, various effects expected according to embodiments of the present disclosure are disclosed in or may be derived from the detailed description below.

### BRIEF DESCRIPTION OF THE DRAWINGS

Since these drawings are only for reference in explaining example embodiments of the present disclosure, the technical idea of the present disclosure should not be interpreted as being limited to the attached drawings.

FIG. 1 is a perspective view showing a lower structure of a vehicle body according to an embodiment.

FIG. 2 is a partial perspective view showing a lower structure of a vehicle body according to an embodiment.

FIG. 3 and FIG. 4 are perspective views showing a partial configuration of a lower structure of a vehicle body according to an embodiment.

FIG. 5 is a perspective view showing a side connecting member that can be applied to a lower structure of a vehicle body according to an embodiment.

FIG. 6 is a drawing showing load paths of a lower structure of a vehicle body according to an embodiment.

FIG. 7 is a cross-sectional view along line A-A of the lower structure in FIG. 6.

FIG. 8 is a cross-sectional view along line B-B of the lower structure in FIG. 6.

FIG. 9 is an exploded perspective view showing a variation of a side connecting member that can be applied to a lower structure of a vehicle body according to an embodiment.

FIG. 10 is a perspective view showing a variation of a side connecting member that can be applied to a lower structure of a vehicle body according to an embodiment.

The drawings referenced above are not necessarily drawn to scale and should be understood as presenting a rather simplified representation of various features illustrating the basic principles of the disclosure. The specific design features of the disclosure, including, for example, specific dimensions, orientation, location, and shape, will be determined in part by the particular intended application and usage environment.

### DETAILED DESCRIPTION OF THE EMBODIMENTS

Hereinafter, with reference to the attached drawings, embodiments of the present disclosure are described in detail so that those of ordinary skill in the art can implement the present disclosure. As those having ordinary skill in the art should realize, the described embodiments may be modified in various different ways, all without departing from the spirit or scope of the present disclosure.

The terminology used in this specification is for the purpose of describing specific examples and is not intended to limit the present disclosure. As used herein, singular forms are intended to also include plural forms, unless the context clearly indicates otherwise.

The terms ‘comprising’, ‘having’, and/or ‘including’ and variations thereof as used in this specification indicate the presence of specified features, integers, steps, operations, elements, and/or components, but at least one other feature, integer, step, operation, element and/or component may be present. It should also be understood that this does not exclude the presence or addition of steps, operations, components, and/or groups thereof.

As used in this specification, the term ‘and/or’ includes any one or all possible combinations of at least one associated listed item.

In this specification, the term ‘coupled’ or ‘connected’ means that components are directly connected to each other by welding, Self-Piercing Rivet (SPR), Flow Drill Screw (FDS), structural adhesive, or the like or indirectly connected through at least one intermediary component, and physical relationship between two components.

The terms ‘vehicle’, ‘of a vehicle’ or other similar terms used in this specification are generally used in relation to passenger automobiles. Such passenger automobiles may include passenger vehicles, sport utility vehicles (SUVs), buses, trucks, and various commercial vehicles. Such passenger automobiles may also include hybrid vehicles, electric vehicles, hybrid electric vehicles, hydrogen power vehicles, and other alternative fuel vehicles (e.g., fuels derived from resources other than petroleum).

In this specification, the ‘front-to-back direction of the vehicle body’ may be defined as the longitudinal or lengthwise direction of the vehicle body. The ‘vehicle width direction’ may be defined as the left-right, lateral, or widthwise direction of the vehicle body. The ‘up-and-down direction’ may be defined as the height or vertical direction of the vehicle body.

Furthermore, in this specification, ‘upper end’, ‘upper portion’, or ‘upper surface’ of a component indicates an end, portion, or surface of a component that is relatively upper in the drawing, and ‘lower end’, ‘lower portion’, or ‘lower surface’ of a component indicates an end, portion, or surface of a component that is relatively lower in the drawing.

Furthermore, in this specification, an end of a component (e.g., one end or another (other) end, and the like) denotes an end of a component in any one direction. An end portion of the component (e.g., one end portion or other (another) end portion, and the like) denotes a portion of a component that includes that end.

Embodiments are hereinafter described in detail with reference to the accompanying drawings.

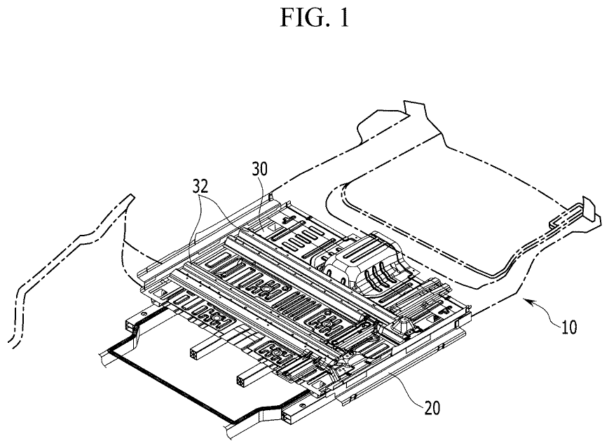

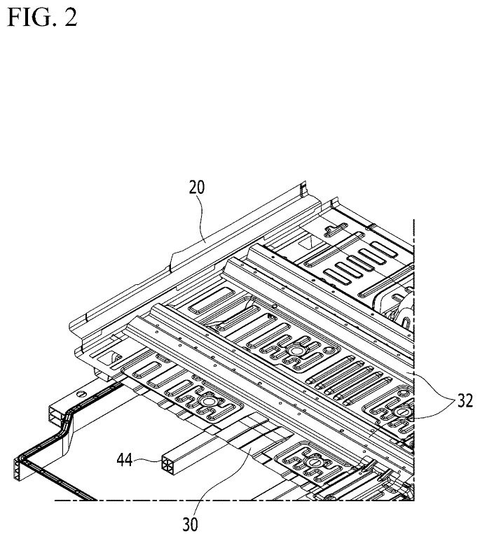

FIG. 1 is a perspective view showing a lower structure of a vehicle body according to an embodiment. FIG. 2 is a partial perspective view showing a lower structure of a vehicle body according to an embodiment.

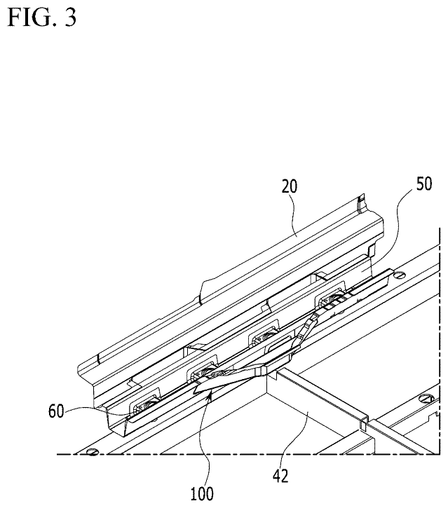

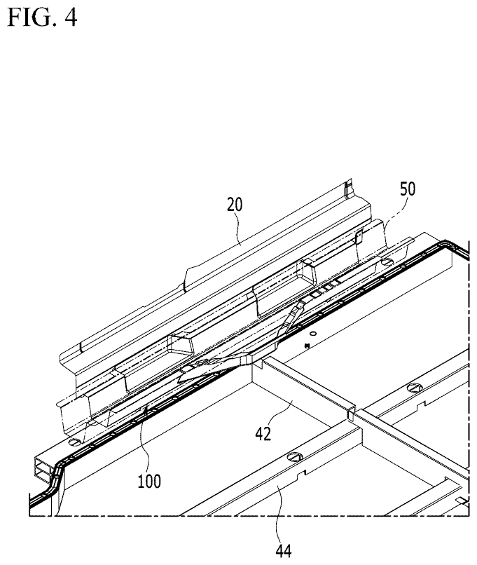

FIG. 3 and FIG. 4 are perspective views showing a partial configuration of a lower structure of a vehicle body according to an embodiment.

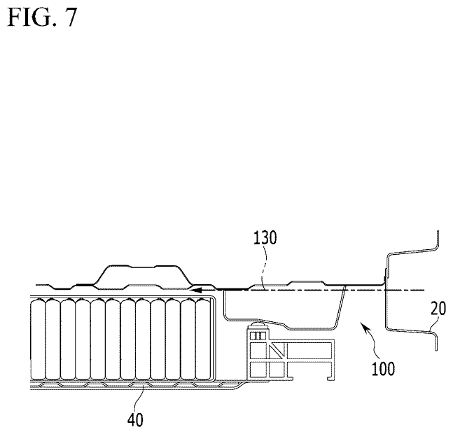

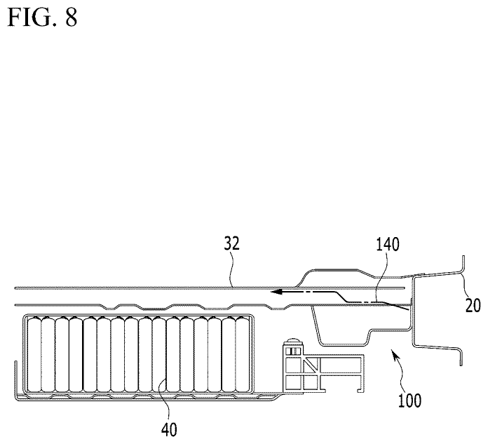

Referring to FIGS. 1-4, a lower structure of a vehicle body according to an embodiment includes a side sill 20 mounted along the front-to-back direction of the vehicle body 10, a battery 40 mounted on the lower part of a center floor 30 (see FIG. 7 and FIG. 8), and a side connecting member 100 provided to transmit collision load between the side sill 20 and the battery 40.

The side sill 20 is disposed on the outside of the center floor 30 and supports the side load of the vehicle body 10. As this should be apparent to those having ordinary skill in the art, a detailed description of its configuration and function has been omitted.

In general, the center floor is a member that makes up the floor of the vehicle cabin, and seats and the like are mounted on the center floor.

To increase the travel distance of a hybrid vehicle or electric vehicle, battery size is increasing. Accordingly, there is an increasing trend to increase space utilization by mounting the high voltage battery at the bottom of the center floor.

Cell To Module (CTM), which is classified as a 4th generation battery in the industry, is generally supported by two battery lateral members.

Generally, two vehicle body lateral members are mounted on the center floor of the vehicle body to secure the lateral direction strength of the vehicle body and to mount components within the vehicle body.

Additionally, the mounting positions of the two battery lateral members and the two vehicle body lateral members match, making it easy to connect them and form a smooth load transfer path.

Cell To Pack (CTP), which is classified as a 5th generation battery in the industry, is generally supported by one battery lateral member and its connection with the two vehicle body lateral members of the existing vehicle body is severed. Therefore, the load transfer path on the side of the vehicle body may be cut off.

For example, when applying a 5th generation battery, there is a lack of connectivity due to the disconnection of the connection structure between the side sill and the mount part of the battery and the line mismatch between the lateral members. This causes the problem of structural deterioration of the side of the floor.

The lower structure of a vehicle body according to an embodiment includes the side connecting member 100 provided to transmit a collision load between the side sill 20 and the battery 40. Even when a 5th generation battery is applied, the connection between the side sill 20 and the battery 40 can be strengthened, the deformation of the vehicle body 10 can be suppressed even when the side of the vehicle body collides, and damage to the battery 40 can be prevented.

In FIG. 3 and FIG. 4, drawing reference numbers 42 and 44 are a battery lateral member 42 and a battery longitudinal member 44 that support the battery 40, respectively. The battery 40 is mounted in the space between the battery lateral member 42 and the battery longitudinal member 44.

The battery lateral member 42 and the battery longitudinal member 44 function as load transfer paths in the lateral and longitudinal directions of the battery 40, respectively.

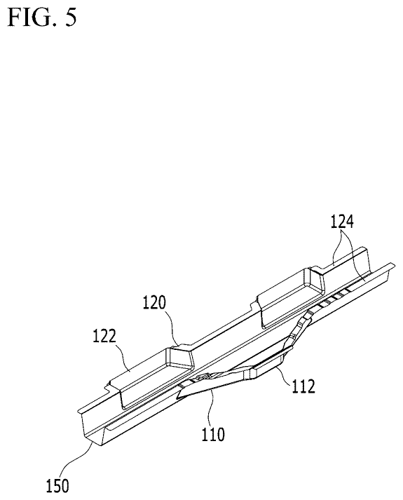

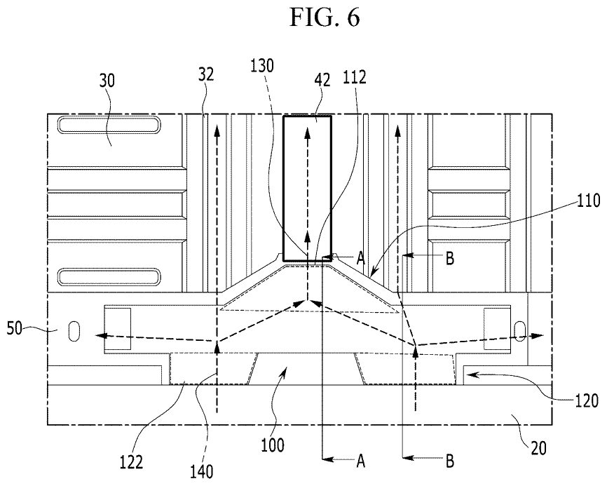

FIG. 5 is a perspective view showing a side connecting member that can be applied to the lower structure of a vehicle body according to an embodiment. FIG. 6 is a drawing showing load paths of the lower structure of a vehicle body according to an embodiment.

FIG. 7 is a cross-sectional view along line A-A in FIG. 6 and FIG. 8 is a cross-sectional view along line B-B in FIG. 6.

Referring to FIGS. 1-8, the side connecting member 100 may include an inner protruding portion 110 that is connected to the battery lateral member 42 mounted along the width direction of the vehicle body 10 to form or define an inner load path 130.

The inner protruding portion 110 protrudes to the inside of the vehicle body 10 at a corresponding position of the battery lateral member 42. Therefore, during a collision with the side of the vehicle, the impact load of the side sill 20 is transmitted to the side connecting member 100. Also, a portion of the impact load transmitted to the side connecting member 100 is transmitted to the battery lateral member 42 through the inner protruding portion 110.

The impact load transmitted to the battery lateral member 42 may be distributed to the vehicle body 10 through the battery lateral member 42 and the battery longitudinal member 44.

Therefore, deformation or damage to the battery 40 can be prevented.

In the drawing, the inner protruding portion 110 is shown as having an inclined protrude configuration, but it is not limited to this configuration.

In other words, the lower structure of a vehicle body according to an embodiment may have various forms including a load transfer end 112 that transfers the collision load to the battery lateral member 42.

The side connecting member 100 may further include an outer protruding portion 120 that is connected to a seat cross-member 32 mounted on the upper part of the center floor 30 along the width direction of the vehicle body 10 to form or define an outer load path 140.

The outer protruding portion 120 protrudes outward in the width direction of the vehicle body 10 and can be connected to the seat cross-member 32 through the center floor 30.

The outer protruding portion 120 may further include a side sill support 122 that supports the side sill 20.

The side sill support 122 may be connected with the side sill 20 and, for example, may be connected with the side sill 20 by welding.

As previously described, the inner protruding portion 110 may protrude to the inside of the vehicle body 10 and the outer protruding portion 120 may protrude to the outside of the vehicle body 10 toward the side sill 20.

Therefore, even if the dimension in the width direction of the vehicle body 10 of the battery 40 has various sizes, it can be responded to by simply changing the design of the inner protruding portion 110 and the outer protruding portion 120.

The side connecting member 100 may further include an upper surface 124 formed on its upper portion to be connected to the center floor 30.

For example, the upper surface 124 may be connected to the center floor 30 in the form of a flange by welding.

Therefore, when the impact load is transmitted to the side connecting member 100, a portion of the impact load can be distributed to the seat cross-member 32 through the upper surface 124 and the center floor 30.

The lower structure of a vehicle body according to an embodiment may further include a vehicle body longitudinal member 50 mounted along the length direction of the vehicle body 10 on the inside of the vehicle body 10 rather than on the side sill 20.

The side connecting member 100 may further include a connector member body 150 surrounding the vehicle body longitudinal member 50.

As shown in FIG. 3, the vehicle body longitudinal member 50 supports the load in the longitudinal direction of the vehicle body 10 and is provided on the inside of the side connecting member 100. This, when the side of the vehicle collides, the vehicle body longitudinal member 50 may transfer the collision load of the side sill 20 to the vehicle body 10 together with the side connecting member 100.

The lower structure of a vehicle body according to an embodiment may further include a longitudinal member bulk head 60 mounted inside the vehicle body longitudinal member 50.

The longitudinal member bulk head 60 supports the vehicle body longitudinal member 50, prevents deformation of the vehicle body longitudinal member 50 when the vehicle collides, and distributes the collision load.

The inner protruding portion 110, the outer protruding portion 120, and the connector member body 150 may be integrally formed.

Therefore, the manufacturing process of the side connecting member 100 is simple and the strength of the side connecting member 100 can be increased.

Additionally, the inner protruding portion 110 and the outer protruding portion 120 may be connected with the connector member body 150.

Therefore, various shapes of the side connecting member 100 can be provided in response to various battery sizes, so it can be applied to the production of multiple vehicle types.

The inner protruding portion 110 includes the load transfer end 112 formed inside the vehicle body 10. A virtual or imaginary extension of the battery lateral member 42 may be formed, i.e., directed or in a direction toward the load transfer end 112.

In other words, in FIG. 6, the virtual extension of the battery lateral member 42 may be the inner load path 130.

A virtual or imaginary extension of the seat cross-member 32 may be formed, i.e., directed or in a direction toward the side sill support 122.

In other words, the virtual extension of the seat cross-member 32 may be the outer load path 140.

Referring to FIGS. 6-8, the side sill 20, the load transfer end 112 of the side connecting member 100, and the battery lateral member 42 form the inner load path 130 to distribute the load during side direction collision of the vehicle body.

In addition, the side sill 20, the side sill support 122 of the side connecting member 100, the upper surface 124, the center floor 30, and the seat cross-member 32 form or define the outer load path 140 during a side direction collision of the vehicle body.

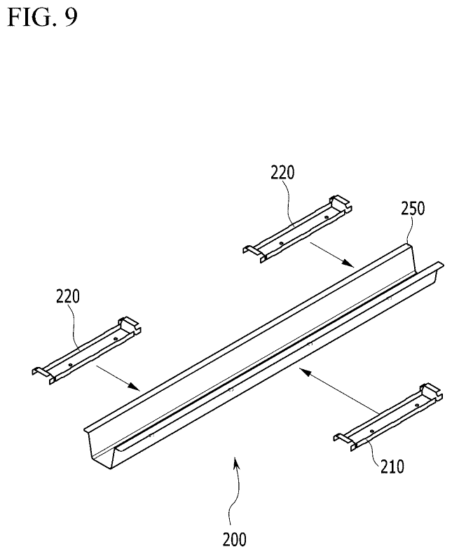

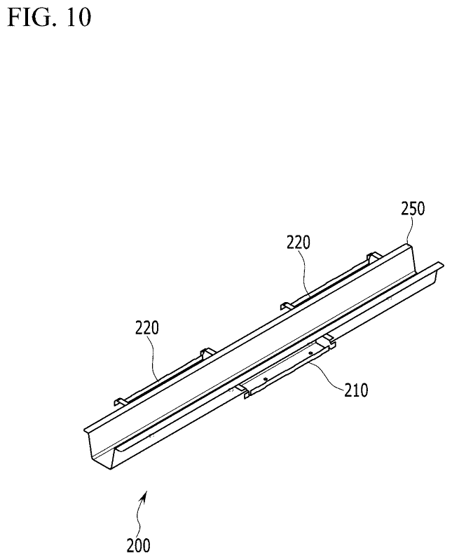

FIG. 9 is an exploded perspective view showing a variation of a side connecting member that can be applied to the lower structure of a vehicle body by an embodiment. FIG. 10 is a perspective assembled view showing a variation of a side connecting member that can be applied to the lower structure of a vehicle body by an embodiment.

In explaining FIG. 9 and FIG. 10, repeated descriptions of the same or similar configuration as the lower structure of a vehicle body according to an embodiment described above have been omitted.

Referring to FIG. 9 and FIG. 10, an inner protruding portion 210 and an outer protruding portion 220 may be connected with a vehicle body longitudinal member 250, thereby forming a side connecting member 200.

In the lower structure of a vehicle body according to the variation of the present disclosure, the side connecting member 200 is formed using the vehicle body longitudinal member 250 to reduce the number of parts and reduce the weight on the vehicle body.

Additionally, by simply changing the design of the inner protruding portion 210 and the outer protruding portion 220, the side strength of the vehicle body can be strengthened without unreasonably increasing production costs, even if the battery specifications are changed.

While the technical concepts of this disclosure have been described in connection with what are presently considered to be practical embodiments, it is to be understood that the disclosure is not limited to the described embodiments. On the contrary, present disclosure is intended to cover various modifications and equivalent arrangements included within the spirit and scope of the appended claims.

<Description of symbols>

| | |
|---|---|
| 10: | vehicle body |
| 20: | side sill |
| 30: | center floor |
| 32: | seat cross member |
| 40: | battery |
| 42: | battery lateral member |
| 44: | battery longitudinal member |
| 50, 250: | vehicle body longitudinal member |
| 60: | longitudinal member bulk head |
| 100, 200: | side connecting member |
| 110, 210: | inner protruding portion |
| 112: | load transfer end |
| 120, 220: | outer protruding portion |
| 122: | side sill support |
| 124: | upper surface |
| 130: | inner load path |
| 140: | outer load path |
| 150: | connector member body |

What is claimed is:

1. A lower structure of a vehicle body, the lower structure comprising:
a side sill mounted along a front-to-back direction of the vehicle body;
a center floor of the vehicle body;
a battery mounted on a lower part of the center floor; and
a side connecting member configured to transmit collision load between the side sill and the battery.

2. The lower structure of claim 1, wherein the side connecting member comprises an inner protruding portion connected to a battery lateral member mounted along a width direction of the vehicle body to define an inner load path.

3. The lower structure of claim 2, wherein the side connecting member further comprises an outer protruding portion connected to a seat cross-member mounted on an upper part of the center floor along the width direction of the vehicle body to define an outer load path.

4. The lower structure of claim 3, wherein:
the inner protruding portion is disposed to protrude toward an inside of the vehicle body; and
the outer protruding portion is disposed on an outside of the vehicle body toward the side sill.

5. The lower structure of claim 3, wherein the outer protruding portion comprises a side sill support supporting the side sill.

6. The lower structure of claim 3, wherein the side connecting member further comprises an upper surface at an upper portion thereof to connect to the center floor.

7. The lower structure of claim 3, further comprising a vehicle body longitudinal member mounted along the front-to-back direction of the vehicle body on the inside of the vehicle body and not the side sill.

8. The lower structure of claim 7, wherein the side connecting member further comprises a connector member body surrounding the vehicle body longitudinal member.

9. The lower structure of claim 8, wherein the inner protruding portion and the outer protruding portion are connected with the connector member body.

10. The lower structure of claim 9, wherein the inner protruding portion, the outer protruding portion, and the connector member body are integrally formed.

11. The lower structure of claim 7, further comprising a longitudinal member bulk head mounted inside the vehicle body longitudinal member.

12. The lower structure of claim 7, wherein the inner protruding portion and the outer protruding portion are connected to the vehicle body longitudinal member.

13. The lower structure of claim 3, wherein:
the inner protruding portion comprises a load transfer end formed inside the vehicle body; and
an imaginary extension of the battery lateral member is directed toward the load transfer end.

14. The lower structure of claim 5, wherein an imaginary extension of the seat cross-member is directed toward the side sill support.
